(19) United States
(12) Patent Application Publication
(10) Pub. No.: US 2018/0135701 A1
(43) Pub. Date: May 17, 2018

(54) BEARING CARRIER, BEARING HOUSING, OR PART OF A BEARING HOUSING, AND METHOD FOR THEIR MANUFACTURE

(71) Applicant: Aktiebolaget SKF, Goteborg (SE)

(72) Inventor: Thomas Krause, Grafenrheinfeld (DE)

(21) Appl. No.: 15/807,772

(22) Filed: Nov. 9, 2017

(30) Foreign Application Priority Data
Nov. 16, 2016 (DE) 102016222600.2

(51) Int. Cl. F16C 35/04; F16C 19/06

(52) U.S. Cl. CPC F16C 35/042; F16C 2212/00; F16C 19/06

(57) ABSTRACT

A bearing carrier or bearing housing or part of a bearing housing includes at least one organic sheet and/or at least one pre-preg. Also an assembly of the bearing carrier or bearing housing or part of the bearing housing and a bearing having an outer ring mounted in the bearing carrier or bearing housing or the part of a bearing housing.

### CROSS-REFERENCE

This application claims priority to German patent application no. 10 2016 222 600.2 filed on Nov. 16, 2016, the contents of which are fully incorporated herein by reference.

### TECHNOLOGICAL FIELD

The present disclosure is directed to an improved structure for a bearing carrier or bearing housing or part of a bearing housing.

### BACKGROUND

A bearing housing made of a short-glass-fiber-reinforced polyamide is known. The relevant fibers are not targeted and are distributed randomly. In addition, bearing housings made of steel are known.

Furthermore, bearing carriers made of steel are known which are very heavy. These can corrode, and, due to their wall thickness, must be manufactured on relatively expensive large-format presses and using punching tools that are also expensive. Because of the investment costs of the presses and the punching tools, the manufacturing of the respective bearing carriers is only worthwhile for relatively high quantities.

### SUMMARY

One aspect of the disclosure comprises, in particular, achieving a high efficiency.

The disclosure is directed to a bearing carrier, or bearing housing, or part of a bearing housing.

According to the disclosure, at least one organic sheet and/or at least one pre-preg is provided. A high efficiency can thereby be achieved. In particular, a targeted introduction of oriented continuous fibers can be achieved, whereby an improved force-supporting and thus a low susceptibility to creep can be achieved, in particular in comparison to short-fiber reinforced polyamide components. In particular a low weight can be achieved. Furthermore, in particular it can be achieved that even small batch sizes are cost-effectively manufacturable. In particular, the use of expensive large-format presses can be avoided. In particular, the organic sheet can be a fabric, made of reinforcing fibers, impregnated with thermoplastic powder, or unidirectional bands, made of reinforcing fibers, impregnated with thermoplastic, wherein the reinforcing fibers can in particular be carbon- and/or glass- and/or aramid fibers. The pre-preg can in particular be a fabric, made of reinforcing fibers, impregnated with partially cured duroplastic resin, or unidirectional bands, made of reinforcing fibers, impregnated with partially hardened duroplastic resin, wherein the reinforcing fibers can in particular be carbon- and/or glass- and/or aramid fibers. Furthermore, in particular an additional corrosion protection can be omitted.

Furthermore, a method is disclosed for manufacturing a bearing carrier and/or a bearing housing and/or a part of a bearing housing, wherein two layers are attached to each other. Accordingly a high efficiency can be achieved.

Further advantages arise from the following description of the drawings. Exemplary embodiments of the disclosure are depicted in the drawings. The drawings, the description, and the claims contain numerous features in combination. The person skilled in the art will also advantageously consider the features individually and combine them into further meaningful combinations.

### BRIEF DESCRIPTION OF THE DRAWINGS

FIG. 1 is a top plan view of a bearing carrier according to the present disclosure with a bearing mounted therein looking in the axial direction of the bearing.

FIG. 2 is a side elevation view of the bearing carrier of FIG. 1, looking in the radial direction of the bearing.

FIG. 3 is a top plan view of a bearing housing according to the present disclosure with a bearing mounted therein looking in the axial direction of the bearing.

FIG. 4 is a side elevation view of the bearing housing of FIG. 3, looking in the radial direction of the bearing.

### DETAILED DESCRIPTION

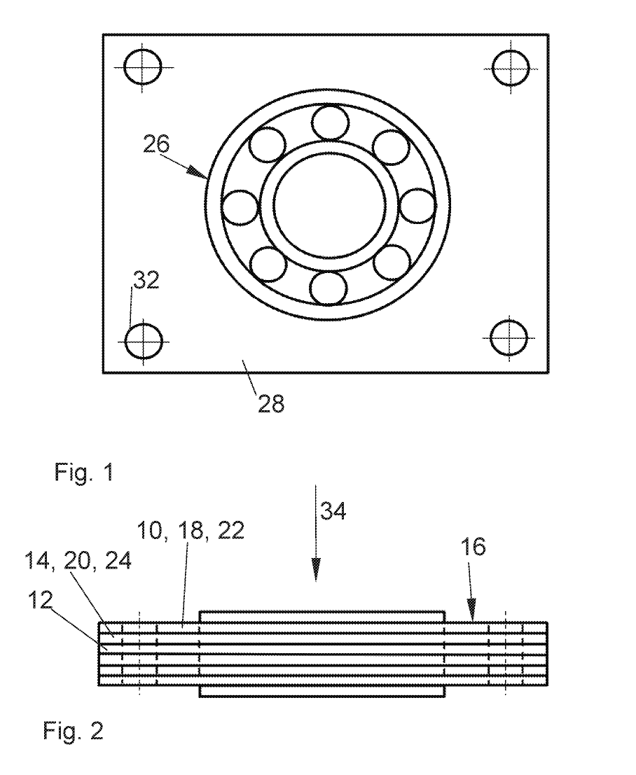

FIG. 1 shows a unit comprising a bearing carrier 28 according to the present disclosure and a bearing 26, wherein the viewing direction is an axial direction of the bearing. The bearing includes an outer ring and an inner ring, which are rotatable relative to each other. The bearing carrier includes four attachment elements 32, using which the bearing carrier together with the bearing are attachable to a housing, for example. The bearing 26 is attached to the bearing carrier by a press-fit.

The bearing carrier includes a layering 16 that is comprised of a plurality of layers (FIG. 2). A first layer 18 of the layering is formed by an organic sheet 10. Furthermore a second layer of the layering is formed by a pre-preg 12. A third layer 20 is disposed between the layer 18 and the pre-preg 12, to which third layer the first layer 18 and the pre-preg 12 are attached. Here the attaching can be effected by an adhesive. The third layer 20 is comprised of an aluminum plate. The layers 18, 20 form parts 22, 24, which are immovable relative to each other since they are attached to each other, and which viewed from a viewing direction 34, which is an axial direction of the bearing, have identically configured circumferential contours.

In other exemplary embodiments the layering can also additionally include one or more steel plates. The various layers occurring in the bearing carrier can be chosen according to the application for which the bearing carrier is to be used such that the bearing carrier has the desired stability and stiffness. In principle, however, in the layering all possible sequences of layers, selected in particular from the materials organic sheet, pre-preg, aluminum plate, and steel plate, are conceivable.

The bearing installed can be a rolling-element bearing or a sliding bearing.

In a method for manufacturing the bearing carrier, the circumferential contour and the bore of individual layers of the layering are cut-out using a laser or another automatic cutting tool. Thereafter the layers 18, 20 are attached to each other, wherein the layers 18, 20 are heated and pressed together. Subsequently the further layers of the layering are individually added, i.e., attached, by heating and pressing. Alternatively it is possible that all layers of the layering are correctly positioned relative to one another, heated, and subsequently pressed together so that a final shape of the bearing carrier arises. An adhesive can optionally be used for the attaching of the layers to one another. The bearing carrier manufactured in this way is now still machinable by drilling or milling.

During manufacturing the bearing is either pressed-in into the individual layers during the pressing of the individual layers, or pressed-in into the bore of the bearing carrier after the manufacturing of the bearing carrier.

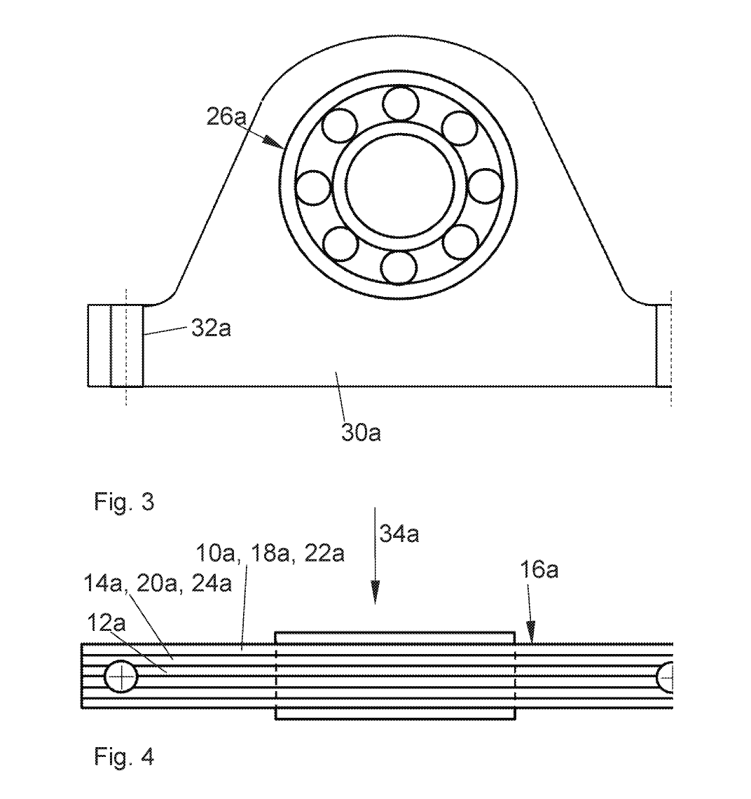

An alternative exemplary embodiment is depicted in FIGS. 3 and 4. Components, features, and functions remaining essentially identical are in general numbered with the same reference numbers. However, to differentiate the exemplary embodiments the letter “a” is added to the reference numbers of the exemplary embodiments in FIGS. 3 and 4. The following description is essentially limited to the differences to the exemplary embodiment in FIG. 1 and FIG. 2, wherein with respect to components, features, and functions remaining the same, reference can be made to the description of the exemplary embodiment in FIG. 1 and FIG. 2.

FIGS. 3 and 4 show an inventive bearing housing 30a, to which a bearing 26a is attached by a press-fit. Just like the bearing carrier 28 that was described in the first exemplary embodiment the bearing housing is constructed by a layering 16a, which is configured analogously to the layering of the bearing carrier. A longitudinal direction of attachment elements 32a of the bearing housing is perpendicular to an axial direction of the bearing.

A manufacturing of the bearing housing and the unit made of housing and bearing is effected in the same steps as the manufacturing of the bearing carrier or of the bearing carrier with the bearing; see exemplary embodiment of Figures one and two.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved bearing carrier or bearing housing or part of a bearing housing.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

10 Organic sheet
12 Pre-preg
14 Aluminum plate
16 Layering
18 Layer
20 Layer
22 Part
24 Part
26 Bearing
28 Bearing carrier
30 Bearing housing
32 Attachment element
34 Viewing direction

What is claimed is:

1. A bearing carrier or bearing housing or part of a bearing housing comprising at least one organic sheet and/or at least one pre-preg.

2. The bearing carrier or bearing housing or part of a bearing housing according to claim 1, including at least one metal plate.

3. The bearing carrier or bearing housing or part of a bearing housing according to claim 2, wherein the at least one metal plate is formed of steel or is formed of aluminum.

4. The bearing carrier or bearing housing or part of a bearing housing according to claim 1, wherein the at least one organic sheet and/or at least one prepreg comprises a first organic sheet and a first prepreg, the first organic sheet and the first prepreg being immovably connected to each other and, when viewed in at least one viewing direction have identical contours.

5. The bearing carrier or bearing housing or part of a bearing housing according to claim 1, comprising a plurality of organic sheets and a plurality of pre-pregs.

6. The bearing carrier or bearing housing or part of a bearing housing according to claim 5, including an adhesive attaching at least a first one of the plurality of organic sheets to a second one of the plurality of organic sheets or attaching the at least a first one of the plurality of organic sheets to one of the plurality of pre-pregs.

7. The bearing carrier or bearing housing or part of a bearing housing according to claim 1, further including a metal plate, wherein the at least one organic sheet and/or at least one pre-preg comprises an organic sheet adhered to a first side of the metal plate and a pre-preg adhered to a second side of the metal plate.

8. The bearing carrier or bearing housing or part of a bearing housing according to claim 7, wherein the metal plate is an aluminum plate.

9. An assembly comprising:
a bearing having an inner ring and an outer ring; and
the bearing carrier or bearing housing or part of a bearing housing according to claim 1;
wherein the outer ring of the bearing is mounted in an opening in the bearing carrier or bearing housing or part of a bearing housing.

10. The assembly according to claim 7, wherein the outer ring of the bearing is press fit in the opening.

11. An assembly comprising:
a bearing having an inner ring and an outer ring; and
the bearing carrier or bearing housing or part of a bearing housing according to claim 8;
wherein the outer ring of the bearing is mounted in an opening in the bearing carrier or bearing housing or part of a bearing housing.

12. A method for manufacturing a bearing carrier and/or a bearing housing and/or a part of a bearing housing according to claim 1 including:
attaching one of the at least one organic sheet to one of the at least one pre-preg.

13. The method according to claim 12, wherein the attaching comprising heating the one of the at least one organic sheet and heating the one of the at least one pre-preg and pressing the one of the at least one organic sheet against the one of the at least one pre-preg.

14. An assembly comprising:
a bearing carrier or bearing housing or part of a bearing housing comprising a plurality of laminations, wherein at least one of the laminations is selected from the group consisting of organic sheets and pre-pregs, the bearing carrier or bearing housing or part of a bearing housing including an opening extending through the plurality of laminations; and
a bearing comprising an outer ring mounted in the opening and an inner ring.

15. The assembly according to claim 14, wherein the outer ring is press-fit in the opening.

16. The assembly according to claim 14, wherein the plurality of laminations are bonded together by an adhesive.

17. The assembly according to claim 14, wherein the plurality of laminations comprises:
a metal plate; and
an organic sheet bonded to a first side of the metal plate.

18. The assembly according to claim 17, wherein the plurality of laminations further comprises a pre-preg bonded to a second side of the metal plate.
